(19) United States
(12) Patent Application Publication
(10) Pub. No.: US 2015/0115597 A1
(43) Pub. Date: Apr. 30, 2015

(54) FLEXIBLE HOSE GUARD

(71) Applicant: Swan Products LLC, Totowa, NJ (US)

(72) Inventor: Steven Lorraine, Glastonbury, CT (US)

(21) Appl. No.: 14/525,725

(22) Filed: Oct. 28, 2014

Related U.S. Application Data
(60) Provisional application No. 61/896,913, filed on Oct. 29, 2013.

(51) Int. Cl. F16L 35/00

(52) U.S. Cl. CPC F16L 35/00
USPC 285/115

(57) ABSTRACT

There is disclosed an anti-kinking device having a neck portion having a threaded internal surface; and a mesh pattern portion connecting the neck portion and a terminal portion; wherein the mesh portion has a central axis and comprises a plurality of equally configured rectangular open spaces between each mesh pattern in a relaxed state, each mesh pattern having a plurality of rectangular inner walls, a plurality of substantially rectangular outer walls, and a plurality of opposing sidewalls connecting the inner and outer walls, the sidewalls having planar linear portions with respect to the central axis. There is also disclosed a hose system comprising a hose inserted through the disclosed device. The device can prevent kinking of the hose.

### FIELD OF THE INVENTION

The present invention relates to garden or other types of hoses, and more specifically is directed to a device to prevent kinking of a hose.

### BACKGROUND OF THE INVENTION

Flexible hose has been manufactured for many years, first out of natural rubber and more recently out of petrochemical derivatives such as synthetic rubber, thermoplastic rubbers or plastics. “Kinking” occurs when the hose is doubled over or twisted. Kinking also occurs due to the routine movements of the user. A consequence of kinking is that the fluid flow through the hose can be either severely restricted or stopped. Kinking is a nuisance, causing the user to waste time unkinking the hose.

Current garden and other types of water hoses may be provided with wire springs or solid plastic “wrenches” in an attempt to prevent kinking. However, when the hose is pulled hard at an angle, thereby putting strain on the hose, the hose kinks at the end of the spring. This also happens with the wrenches.

The conventional wire springs are attached to the ferrule of a garden hose by decreasing the diameter of the first coil of the spring. However, this makes it difficult to attach and remove from the ferrule. Additionally, the rigid wire springs are prone to corrosion because they are subjected to the outside elements, e.g., temperature and weather changes.

### BRIEF SUMMARY OF THE INVENTION

In an aspect, there is provided an anti-kinking device for a hose system comprising a neck portion having a threaded internal surface; and a coil portion connecting the neck portion and a terminal portion; wherein the coil portion has a central coil axis and comprises a plurality of spaced apart windings with open spaces between each winding in a relaxed state, each winding having a substantially cylindrical inner wall, a substantially cylindrical outer wall, and sidewalls connecting the inner and outer walls, the sidewalls having planar angled portions with respect to the coil axis; wherein the device is a substantially cylindrical body having a through bore; and wherein the planar angled portions of the sidewalls engage to prevent the windings from slipping against each other when the windings are in a bent state.

In another aspect, there is also provided a hose inserted through the anti-kinking device; and a ferrule having a plurality of parallel concentric rings on the outer surface and attached to an end of the hose; wherein the threaded internal surface of the neck portion of the device is attached to the plurality of parallel concentric rings on the outer surface of the ferrule.

In a further aspect, there is provided a hose having a female end inserted through the anti-kinking device; and a coupler having a tail inserted into the female end of the hose; wherein the female end of the hose is crimped between the threaded internal surface of the neck portion of the device and the coupler.

Moreover, there is provided, in another aspect, a hose having a female end and a male end and inserted through two anti-kinking devices; wherein the terminal portion of each device is positioned towards a center of a length of the hose, and the neck portion of one of the two devices is positioned towards the female end of the hose and the neck portion of the second of the two devices is positioned towards the male end of the hose; a ferrule having a plurality of parallel concentric rings on the outer surface is crimped onto the male end of the hose; wherein the threaded internal surface of the neck portion of the second of the two devices is attached to the plurality of parallel concentric rings on the outer surface of the ferrule; and a coupler having a tail is inserted into the female end of the hose; wherein the female end of the hose is crimped between the threaded internal surface of the neck portion of one of the two devices and the coupler.

Further, there is provided a hose having a female end and a male end and inserted through an anti-kinking device comprising a neck portion having a threaded internal surface; and a coil portion connecting the neck portion and a terminal portion having a threaded internal surface; and a ferrule having a plurality of parallel concentric rings on the outer surface and attached to a female end of the hose; wherein the threaded internal surface of the neck portion of the device is attached to the plurality of parallel concentric rings on the outer surface of the ferrule.

Further, in another embodiment, there is provided an anti-kinking device for a hose system comprising a neck portion having a threaded internal surface; and an alternating mesh pattern portion connecting the neck portion and a terminal portion; wherein a plurality of interconnected alternating mesh pattern portions has a central axis and comprises a plurality of equally spaced rectangular open spaces between each mesh pattern in a relaxed state, each mesh pattern having a plurality of substantially rectangular inner walls, a plurality of substantially rectangular outer walls, and a plurality of sidewalls connecting the inner and outer walls, the plurality of opposing sidewalls having planar linear portions with respect to the central axis; wherein the device is a substantially cylindrical body having a through bore; and wherein the planar linear portions of the opposing sidewalls prevent the mesh patterns from slipping against each other when the device is in a bent state.

### BRIEF DESCRIPTION OF THE DRAWINGS

FIG. 1A is a perspective view of a device according to one embodiment of the invention, the device including a neck portion, coil portion, and terminal portion;

FIG. 1B is a perspective view of the device of FIG. 1A, rotated 90 degrees;

FIG. 1C is a longitudinal cross-sectional view of the device of FIG. 1A;

FIG. 1D is an end view of the terminal portion of the device of FIG. 1A;

FIG. 1E is an end view of the neck portion of the device of FIG. 1A;

FIG. 1F is a perspective view showing the neck portion of the device of FIG. 1A having a threaded internal surface;

FIG. 2 is a perspective view of a ferrule having a plurality of parallel concentric rings on the inner and outer surfaces;

FIG. 3 is a perspective view of a coupler having a smooth cylindrical tail portion, and a neck portion with a threaded internal surface and hexagonal outer surface;

FIGS. 4-8 are a series of perspective views illustrating the steps of an assembly process for attaching the device of FIG. 1A to a hose, wherein FIG. 4 shows a hose inserted through the device of FIG. 1A;

FIG. 5 shows a ferrule having a plurality of parallel concentric rings on the outer surface attached to the hose assembly of FIG. 4;

FIG. 6 shows both the ferrule and a coupler at the end of the hose assembly;

FIG. 7 shows the device, a ferrule (not visible), and a coupler fully assembled on the end of the hose;

FIG. 8A is a perspective view of the fully assembled hose system of FIG. 7 attached via the coupler to a faucet, wherein no strain has been placed upon the hose;

FIG. 8B is a perspective view of the fully assembled hose system of FIG. 7, wherein a strain has been placed upon the hose and wherein the device prevents kinking of the bent hose;

FIG. 9A is a perspective view of a hose system, according to another embodiment of the invention, showing a hose inserted through the device of FIG. 1A, with a coupler inserted into the end of the hose, and without a ferrule.

FIG. 9B is a perspective view of the hose system according to another embodiment of the invention, showing an anti-kinking device and a coupler fully attached on the end of the hose, but without a ferrule present;

FIG. 10A is a longitudinal cross-sectional view of an anti-kinking device according to another embodiment of the invention, the device including a neck portion, coil portion, and a terminal portion;

FIG. 10B is an end view of the terminal portion of the device of FIG. 10A;

FIGS. 11A-D are a series of perspective views illustrating the steps of an assembly process according to another embodiment of the invention, for attaching two devices of FIG. 1A to a hose, wherein FIG. 11A shows a hose inserted through two devices;

FIG. 11B shows a ferrule having a plurality of parallel concentric rings on the outer surface attached to each end of the hose system of FIG. 11A;

FIG. 11C shows a ferrule at the male end of the hose, and a coupler at the female end, without a ferrule, according to another embodiment of the invention, of the hose system of FIG. 11A;

FIG. 11D shows the two devices, a ferrule (not visible on the male end of the hose), and a coupler, fully assembled at each end of the hose system;

FIGS. 12A-C are a series of perspective views illustrating the steps of an assembly process according to another embodiment of the invention for attaching the device of FIG. 10A to a hose wherein FIG. 12A shows a hose inserted through the device;

FIG. 12B shows a ferrule fully assembled at the male end of the hose, and a ferrule (on the female end is not visible) and coupler, fully assembled at the female end of the hose system;

FIG. 12C shows a device of FIG. 10A and a ferrule (not visible on the male end of the hose) fully assembled at the male end of the hose system, and a ferrule and a coupler fully assembled at the female end of the hose system;

FIG. 13 is a longitudinal cross-sectional view of an anti-kinking device according to another embodiment of the invention, the device including a neck portion, coil portion, and a terminal portion.

FIG. 14 is a perspective view of a device according to one embodiment of the invention, the device including a neck portion, alternating mesh portion and terminal portion;

FIG. 15 is a perspective side view of the device in FIG. 14;

FIG. 16 is a perspective side view of the device in FIG. 15 rotated 90 degrees;

FIG. 17 is an end view of the terminal portion of the device of FIG. 14;

FIG. 18 is a longitudinal cross-sectional view of the device in FIG. 14 showing the neck portion of the device and the threaded internal surface;

FIG. 19 is a perspective view of a hose ferrule being inserted into the neck portion of the device shown in FIG. 14;

FIG. 20 is a perspective view of a hose ferrule inserted into the neck portion of the device shown in FIG. 14.

### DETAILED DESCRIPTION

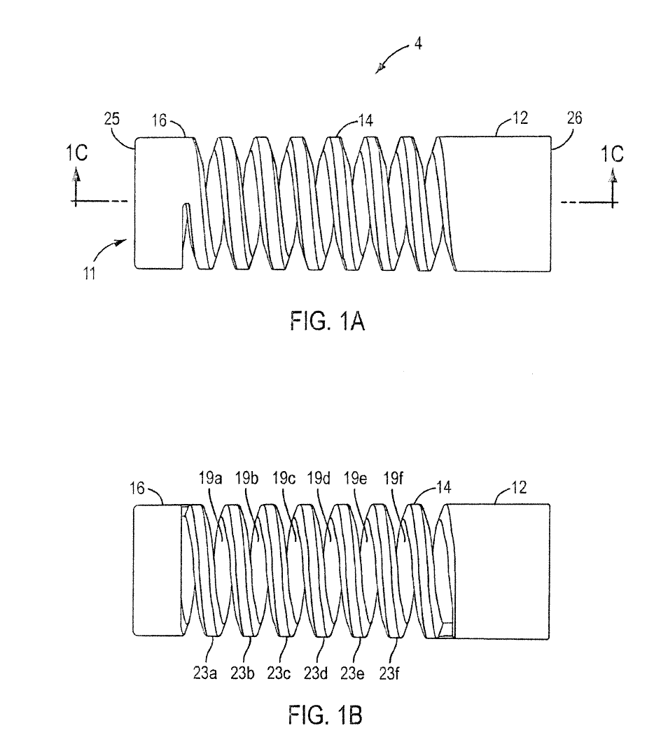

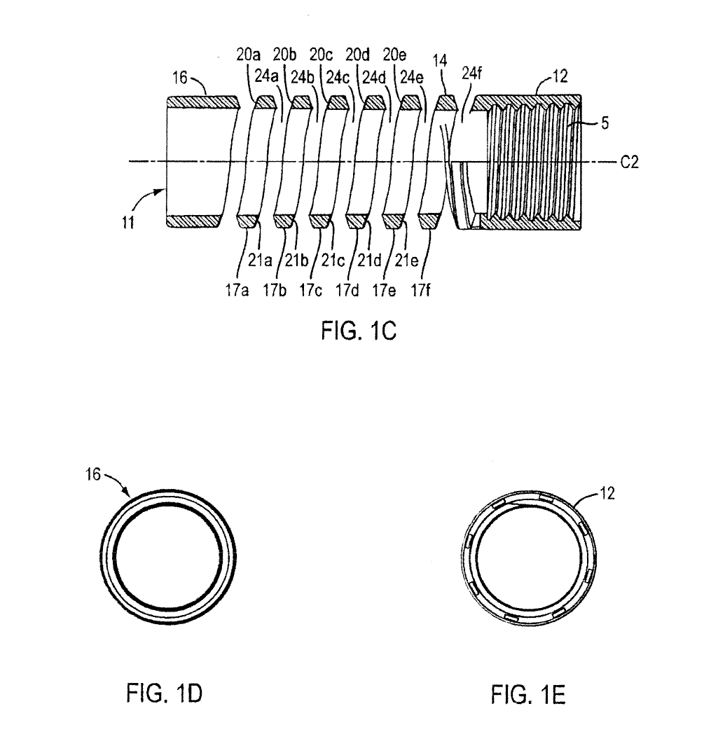

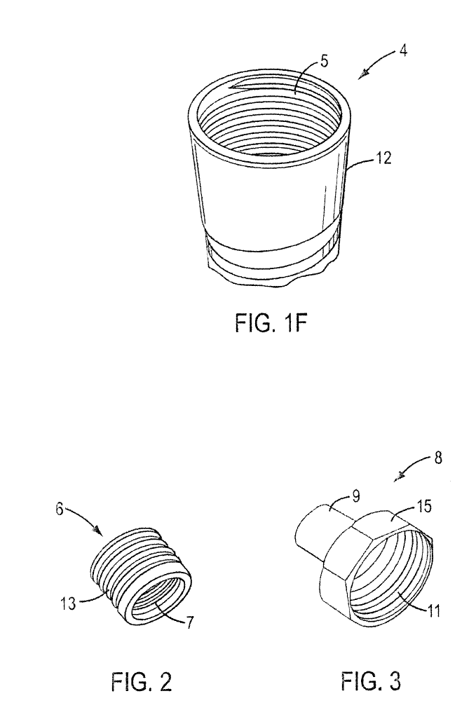

The present invention is directed to a device applied to a hose that can reduce the likelihood of kinking of the hose, and in particular will reduce kinking of a hose portion adjacent to a faucet or at the base of the device, when a strain has been placed on the hose, such as when the hose is pulled at an angle. As shown in the embodiment of FIGS. 1A-C, the anti-kinking device 4 is a substantially cylindrical body having a through bore if and including a neck portion 12 at one end 26; a terminal portion 16 at the opposing end 25; and a central coil portion 14 connecting the neck portion 12 and the terminal portion 16. The device has a central cylindrical axis C2. As shown in FIGS. 1C, 1E, and 1F, the neck portion 12 has a threaded internal surface 5, here more specifically a helical threaded internal surface. In an alternative embodiment, the neck portion can have a grooved or corrugated internal surface, e.g., parallel concentric rings. However, the helical threaded internal surface 5 is preferred because it provides more surface contact area for attachment to the plurality of parallel concentric rings of a ferrule. Also, rotation of the helical threaded internal surface of the device and the rings of the ferrule will move the device up (longitudinally along the cylindrical axis of) the ferrule, e.g., by using a twisting motion, to provide a tighter attachment to the ferrule.

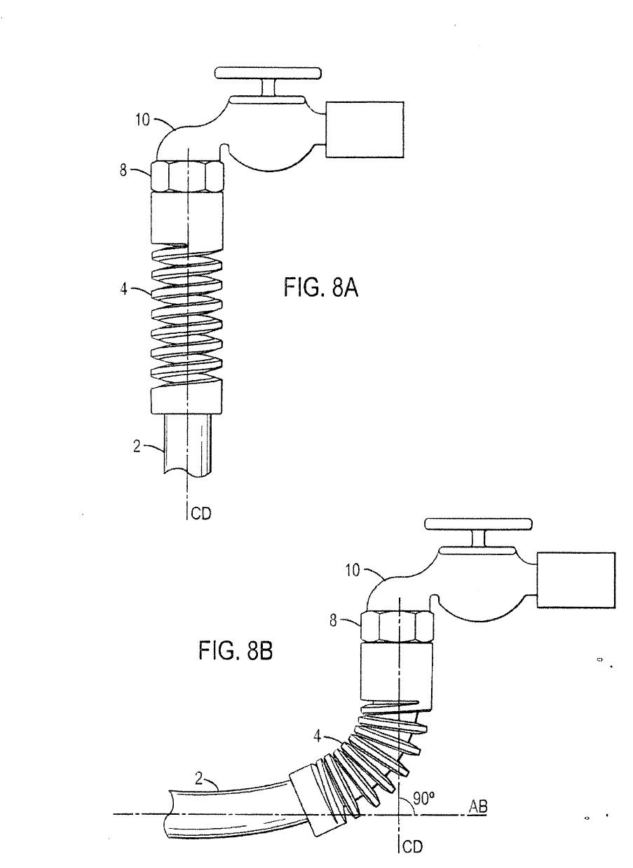

As shown in FIGS. 1A-C, the coil portion 14 has a central axis C2 and comprises a plurality of spaced apart windings, e.g., 17a, 17b, 17c, etc. with open spaces, e.g., 24a, 24b, 24c, etc between the windings. Each winding has a substantially cylindrical inner wall 19, a substantially cylindrical outer wall 23 concentric with the inner wall, and sidewalls 20, 21 connecting the inner and outer walls. The sidewalls having planar angled portions with respect to the coil axis. More specifically, the opposing sidewalls are oppositely angled so as to converge toward the outer wall, such that the outer wall is of a lesser length than the inner wall. The planar angled portion of the sidewalls prevents the windings from slipping against each other and causing the device to lose its shape, as occurs with the prior art circular wirings. In particular, the planar angled portions of the adjacent windings engage each other to reduce the strain being placed on the hose. A cross-sectional view of a winding has the general shape of a trapezoid, wherein the inner and outer wall are roughly parallel to each other, the angles formed between the sidewalls and the inner wall are acute, and the angles formed between the planar angled sidewalls and the outer wall are obtuse, and the sidewalls converge radially going from the (longer) inner wall toward the (shorter) outer wall. The corners of the inner walls act like hinge points when the coil portion is bent, i.e., the adjacent corners of two adjacent coils will meet and the adjoining sidewalls will converge and nest one alongside the other as shown in FIG. 8B.

The coil windings are thus designed to nest along their outer walls and prevent the collapse or kinking of the hose portion located inside the device. In particular, as shown in FIG. 8A, when no strain is placed on the hose (the hose is linear), the coil windings are in a relaxed state (linear, spaced apart relation) along axis line CD. However, as shown in FIG. 8B, when a strain is placed upon the hose along axis line AB, then the angled portion of the sidewalls of device 4 engage each other to prevent the hose 2, which has been inserted through the device 4, from kinking either near the faucet or at the end of the terminal portion of the device.

As shown in FIG. 1D, the terminal portion 16 of the device can be smooth on both the outside and inside surfaces. The device can have substantially the same inner diameter throughout the length of the device. The size of the inner diameter is not particular to the device, so long as a hose can be inserted there through and the neck portion of the device can attach onto a ferrule at an end of the hose. In particular, the threaded internal surface of the neck portion of the device can engage the plurality of parallel concentric rings on the outer surface of a ferrule. In other aspects, the device can be tapered toward the terminal portion or toward the neck portion.

The device can be made from durable materials that will withstand temperature and weather changes. In an aspect, the device is made from synthetic polymers, such as nylon and plastics, including thermosetting and thermoplastics, selected from the group consisting of acrylonitrile butadiene styrene (ABS), nylon, acrylics, celluloid, cellulose acetate, cyclic olefin copolymer, ethylene-vinyl acetate (EVA), ethylene vinyl alcohol (EVOH), fluoroplastics, polyacrylates, polyacrylonitriles, polyamides, polyamide-imide, polyaryletherketone, polybutadiene, polybutylene, polybutylene terephthalate, polycaprolactone, polychlorotrifluoroethylene, polycarbonate, polyester, polyethylene, polyetherimide, polyethersulfone, polyimide, polyphenylene oxide, polypropylene, polystyrene, polysulfone, polyurethane, polyvinyl acetate, polyvinyl chloride, polyvinylidene chloride, and styrene-acrylonitrile. Any plastic material with or without other nonplastic fillers may be used, so long as the coil windings are flexible and will bend along with the hose when a bending force, e.g., a strain, is applied to the hose.

The device disclosed herein can be used in a hose system. The hose system can comprise a hose, at least one anti-kinking device, optionally at least one ferrule, and optionally a coupler. In one embodiment, as shown in FIGS. 4-8, the hose system comprises a hose 2, the anti-kinking device 4, a ferrule 6, and a coupler 8. Various permutations of the disclosed hose system are contemplated herein and will be discussed further below.

The hose 2 for use in the disclosed hose system can be flexible and may be made from multi-ply vinyl, rubber, and non-reinforced vinyl. For example, the hose may be made from soft vinyl plastic, natural rubber, synthetic rubber or thermoplastic rubber. The hose can be cut squarely at one end and any burrs can be removed in order to insert the hose into the anti-kinking device.

As disclosed herein, the hose system can comprise at least one ferrule 6. A ferrule 6 is a sleeve or cap, typically metal that can be used to attach a coupling 8 to a hose 2. The inside diameter of the ferrule 6 should be sized to slip over the hose for which the ferrule is intended. In an aspect, the inner diameter of the ferrule 6 can range from about 0.2″ to about 1.0″, from about 0.38″ to about 0.75″, and from about 0.45″ to about 0.625″. The length of the ferrule 6 can be from about 0.4″ to about 1.5″, from about 0.5″ to about 1.0″, and about 0.625″ to about 0.72″. The size of the hole at the end of the ferrule 6 should be big enough to accept a coupling tail 9.

The internal 7 and outer 13 surface of the ferrule 6 can have a plurality of parallel concentric rings, as shown in FIG. 2. The parallel concentric rings allow the threaded internal surface of the neck portion of the device to grab and move up, e.g., by twisting the device, the ferrule thereby providing a stronger attachment. In an aspect, the internal and outer surface of the ferrule can be smooth.

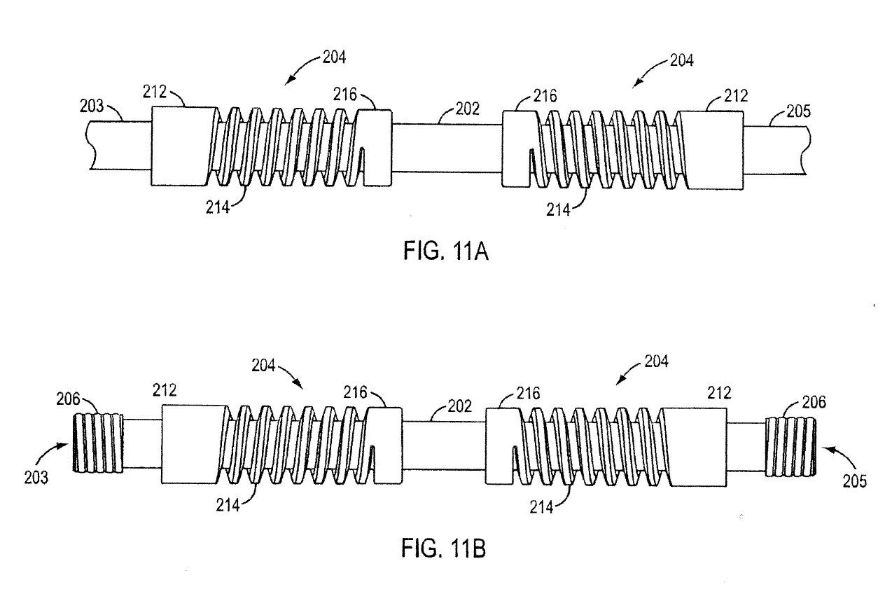

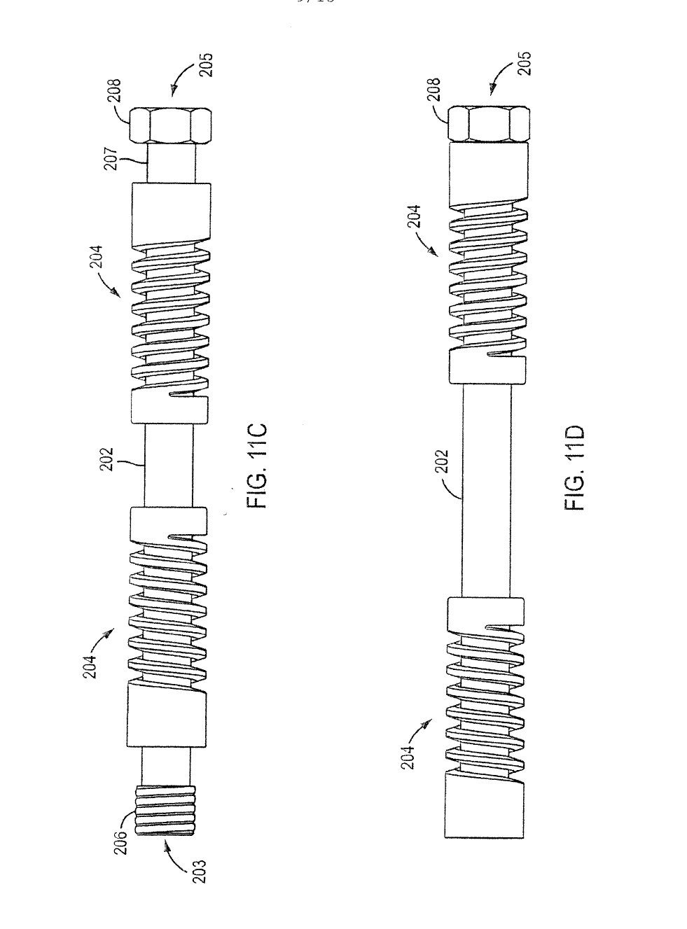

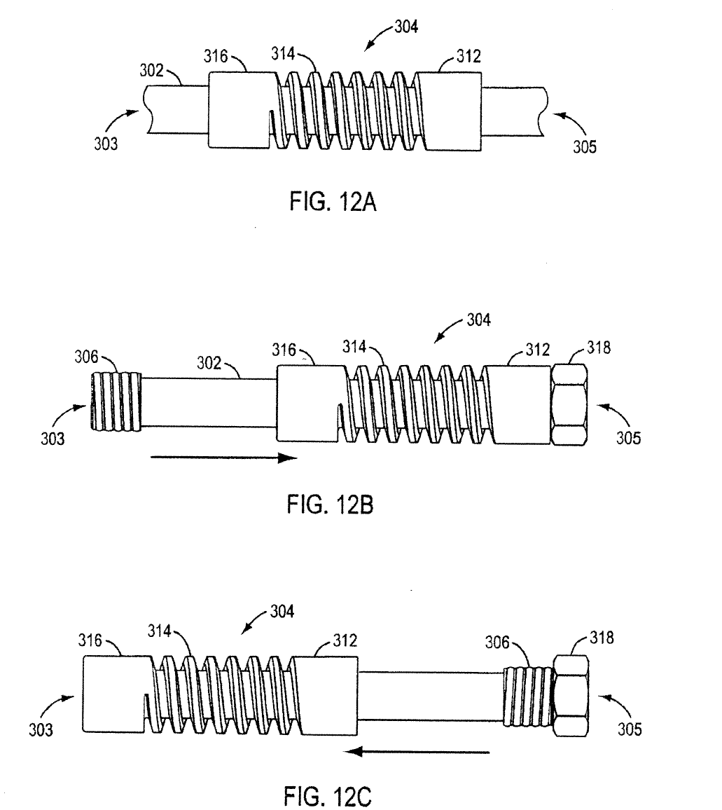

In an embodiment, a ferrule 306 can be present at the female end of the hose 305 and at the male end of the hose 303, as shown in FIGS. 12B-C. In another embodiment, a ferrule 206 can be present at just the male end of the hose 203, as shown in FIG. 11C.

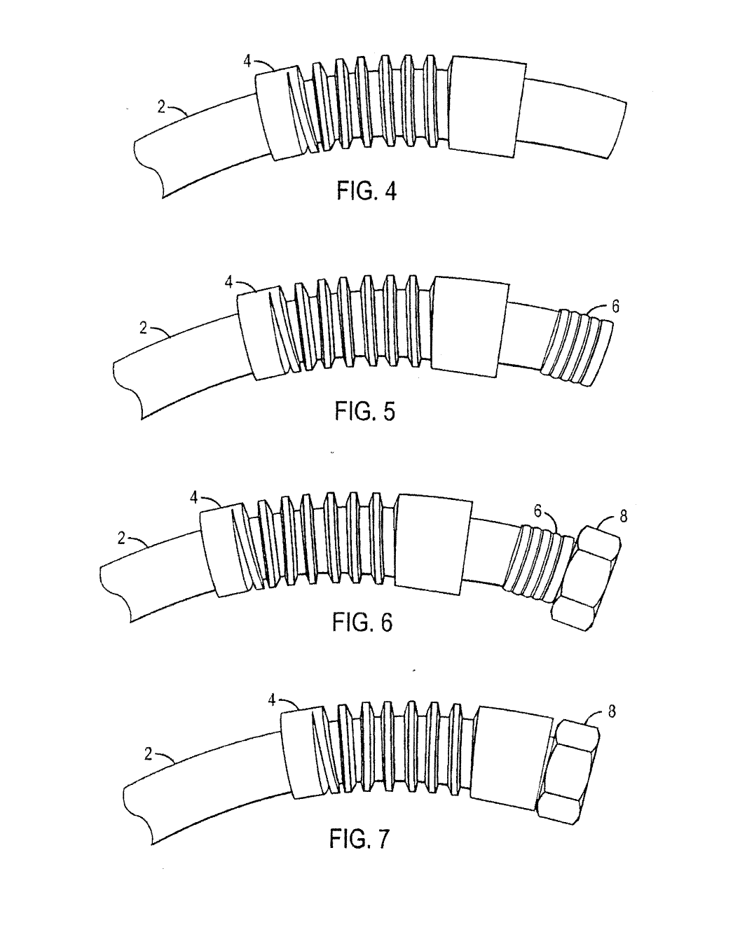

The coupling 8, for use in the disclosed hose system, is a fitting that allows a hose 2 to be fastened either to an additional hose or some type of faucet 10. There are also couplings known as expansion hose fittings that effectively enable a hose of one diameter to couple with a second hose of a larger diameter. As shown in FIG. 3, the outer diameter of the tail 9 of the coupling 8 must be able to slide into the hose 2, for example 7/16 inch, 19/32 inch, ½ inch, ⅝ inch, and ¾ inch. The length of the tail 9 should match the length of the ferrule 6. The coupling 8 can have a threaded internal surface ii for attachment to a faucet and an outer hexagonal surface of the neck portion 15 of the coupling.

The coupler and the ferrule can be made from any suitable material, such as brass, aluminum, copper, plated steel, steel, and stainless steel. Steel with zinc or nickel plating is also an option. For those applications, where the hose is designed to deliver potable water, lead free brass may be used. The ferrules and couplers may be annealed for ease of crimping.

A method of making a hose system, according to one embodiment of the invention, is illustrated in FIGS. 4-7. FIG. 4 illustrates a hose 2 inserted through the device 4 of FIGS. 1A-F. A ferrule 6 is then placed onto an end of the hose, as illustrated in FIG. 5. A coupler 8 having a tail is then inserted into the end of the hose having a ferrule, as illustrated in FIG. 6. The coupler and ferrule are then crimped.

Crimping of ferrules and/or couplings and/or the disclosed device onto hoses can be achieved by any technique known in the art, such as those disclosed in U.S. Pat. No. 4,867,485, the disclosure of which is hereby incorporated by reference. In the embodiment illustrated in FIG. 6, the ferrule 6 and the coupler 8 are placed onto the hose 2. The fingers of a crimping machine are inserted into the hose with the ferrule and coupler in place. The fingers then apply physical pressure to the inside surface of the tail of the coupler thereby deforming some portion of the tail 9 of the coupler 8 and crimping the hose 2 into the inside surface of the ferrule 7, as shown in FIG. 2. The crimping is done in a corrugated fashion, i.e., there are areas of greater and lesser compression.

After crimping the coupler 8 and ferrule 6 onto the hose 2, the neck portion of the device 4 is then moved up and over the outer surface of the ferrule, as shown in FIG. 7. In particular, the threaded internal surface of the device can engage the parallel concentric rings on the outer surface of a ferrule 6, as shown in FIGS. 6-7. In an aspect, the device can be twisted onto the ferrule thereby allowing the threaded internal surface to move up and over the parallel concentric rings. In this manner, the device can be “attached” to the ferrule when in use and can be unattached from the ferrule when it is no longer needed.

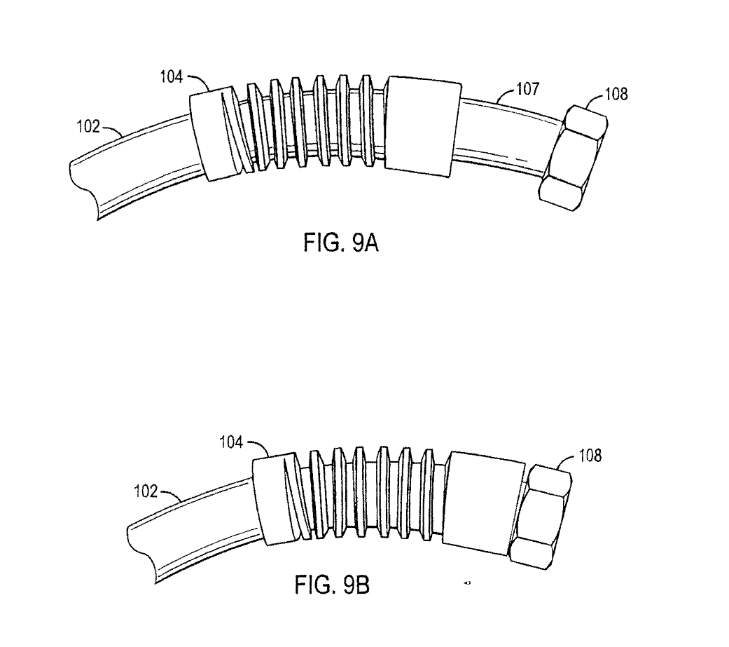

In another embodiment for making a hose system, a hose system comprising a hose, the anti-kinking device, and a coupler, is shown in FIGS. 9A-B. The hose 102 is inserted through the device 104, and a coupler 108 is inserted into one end of the hose, without the presence of a ferrule 107. The device 104 is then slid up the hose towards the base of the outer surface of the coupler. The coupler, hose, and device are then crimped such that the outward expansion of the hose and tail of the coupler during the crimping process create a friction fit thereby holding the anti-kinking device in place at one end of the hose. In this embodiment, the device cannot be moved, i.e, slid up and down the hose, as in the first embodiment. This embodiment provides a cost savings and increased time efficiency during manufacture by eliminating the time and expense of installing a ferrule at the female end of the hose.

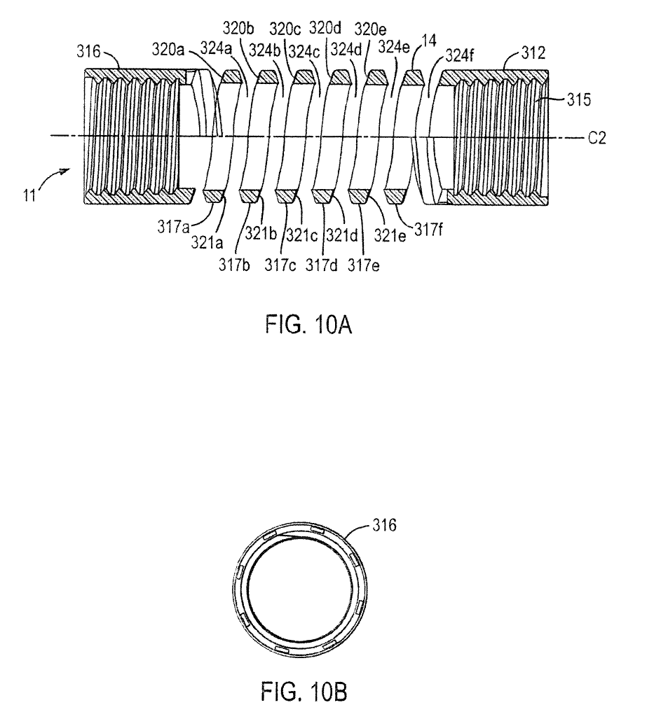

A typical garden or water hose has a female end and a male end, wherein each end has a ferrule. The present invention therefore contemplates a device 304 wherein both the neck portion 312 and the terminal portion 316 have threaded internal surfaces, as shown in FIGS. 10A-B. The device 304 is a substantially cylindrical body having a through bore 311 and including a neck portion 312 at one end having a threaded internal surface 315; a terminal portion 316 at the opposing end having a threaded internal surface; and a central coil portion 314 connecting the neck portion 312 and the terminal portion 316. The device has a central cylindrical axis C2 and comprises a plurality of spaced apart windings, e.g., 317a, 317b, 317c, etc. with open spaces, e.g., 324a, 324b, 324c, etc between the windings. Each winding has a substantially cylindrical inner wall, a substantially cylindrical outer wall, and sidewalls 320a, 321a connecting the inner and outer walls. The sidewalls having planar angled portions with respect to the coil axis.

A hose system for use with the device 304 of FIG. 10A comprises a hose, at least one ferrule, and the device 304 wherein both the neck portion and the terminal portion have threaded internal surfaces. To make such a hose system, a hose 302 having male end 303 and female end 305 would be inserted through the device 304, as shown in FIG. 12A. The device having a terminal portion 316, a coil portion 314, and a neck portion 312. A ferrule 306 would then be placed onto the female end of the hose 305, and a male end of the hose 303. A coupler 318 would also be placed into the female end of the hose 305. The ferrules and couplers would then be crimped onto the hose. When in use, the device 304, by its neck portion having a threaded internal surface, can be attached onto the ferrule 306 at the female end of the hose 305, as shown in FIG. 12B (the ferrule at the female end of the hose is not visible). The device 304 can then be detached from the ferrule 306 at the female end of the hose, slid down the length of the hose 302, and attached onto the ferrule 306 at the male end of the hose 303 using the terminal portion having a threaded internal surface of the device 304, as shown in FIG. 12C (the ferrule at the male end of the hose is not visible).

In another embodiment, there is disclosed a hose system comprising a hose 202, at least one of the disclosed devices 204, at least one ferrule 206, and optionally a coupler 208, as shown in FIGS. 11A-D. For example, a hose 202 could be inserted through two devices (204), wherein each device has a neck portion 212 having a threaded internal surface, a coil portion 214, and a terminal portion 216. In this embodiment, the terminal portion 216 of each device 204 should be positioned toward the center of the hose 202 and the neck portion 212 of each device 204 should be positioned toward the female 205 and male 203 ends of the hose 202, as shown in FIG. 11A. A ferrule 206 should be placed onto each end 203, 205 of the hose 202, as shown in FIG. 11B. In an alternative embodiment, a ferrule 206 can be placed on the male end 203 of the hose 202 and a coupler 208 can be placed onto the female end 205 of the hose, wherein the female end of the hose does not have a ferrule 207, as shown in FIG. 11C. The ferrule 206 on the male end 203 of the hose is then crimped. The device 204 on the female end of the hose is slid so that the neck portion abuts the base of the coupler 208 and the two are crimped onto the hose. The device 204 near the male end of the hose is slid down the length of the hose so that the neck portion of the device 204 slides up and over the parallel concentric rings of the ferrule 206 which has been crimped on the male end of the hose 203, as shown in FIG. 11D. In this embodiment, the hose 202 is prevented from kinking as a result of a strain placed on the hose at both the female and male ends.

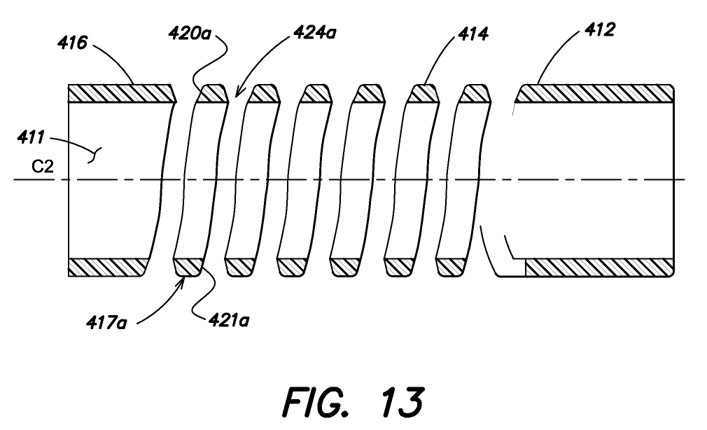

In a further embodiment as shown in FIG. 13, there is disclosed an anti-kinking device comprising a neck portion 412, a coil portion 414 connecting the neck portion 412 and a terminal portion 416; wherein the coil portion 414 has a central coil axis C2 and comprises a plurality of spaced apart windings 417a with open spaces 42a between each winding in a relaxed state, each winding having a substantially cylindrical inner wall, a substantially cylindrical outer wall, and sidewalls 420a, 421a connecting the inner and outer walls, the sidewalls having planar angled portions with respect to the coil axis; wherein the device is a substantially cylindrical body having a through bore 411; and wherein the planar angled portions of the sidewalls engage to prevent the windings from slipping against each other when the windings are in a bent state. In particular, the neck portion has a smooth internal surface.

As can be seen, the disclosed hose system can comprise various components, such as a hose, at least one device, optionally at least one ferrule, and optionally a coupler. Any and all permutations on the above-described embodiments are contemplated.

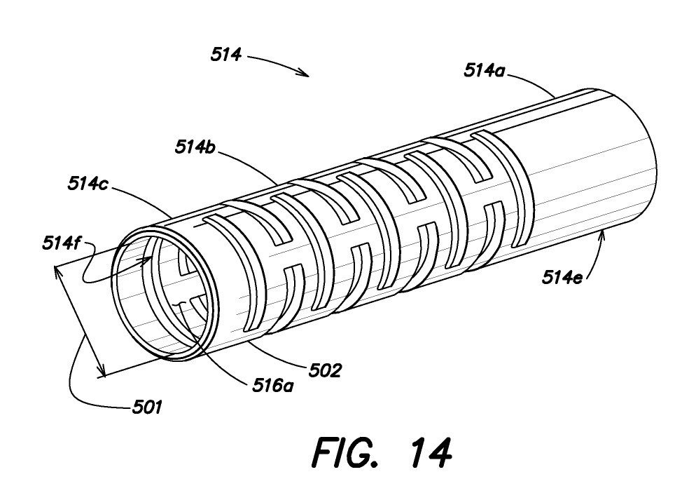

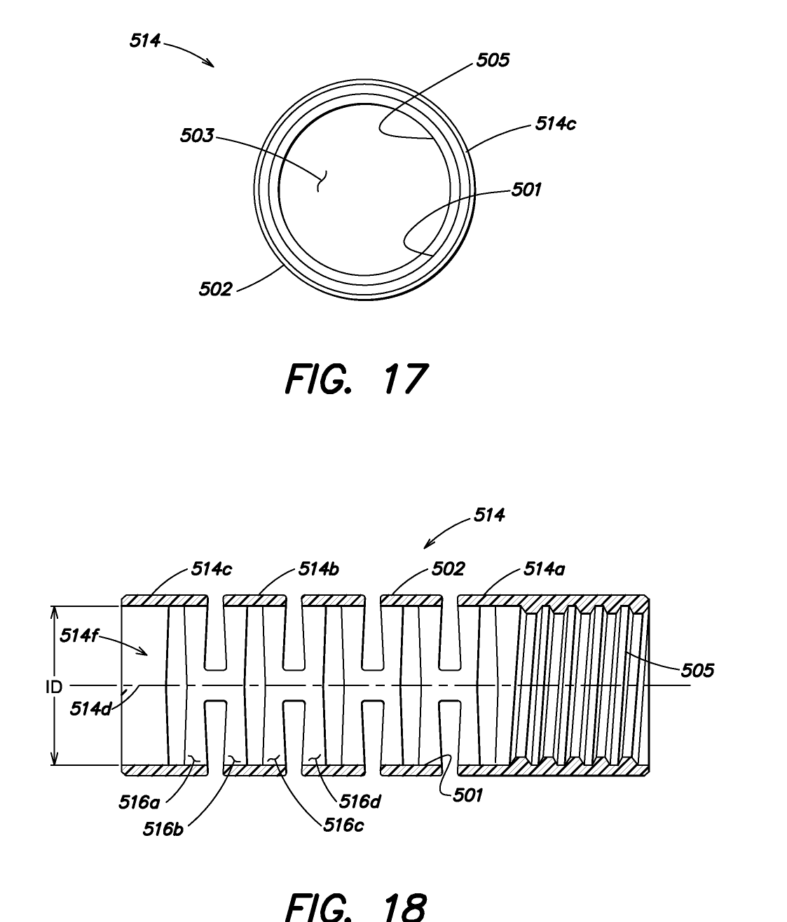

In another embodiment, as shown in FIG. 14, there is disclosed an anti-kinking device 514 for a hose system comprising a neck portion 514a having a threaded internal surface 505 (as shown in FIG. 18), and a plurality of interconnected alternating mesh pattern portions 514b connecting the neck portion 514a and a terminal portion 514c. The device 514 comprises a tubular body 514e which in the present embodiment is circular cylindrical, with inner ID and outer OD circumferential (circular cylindrical) surfaces 501, 502 respectively and an open bore 503 extending the complete axial length of the device (see FIG. 17).

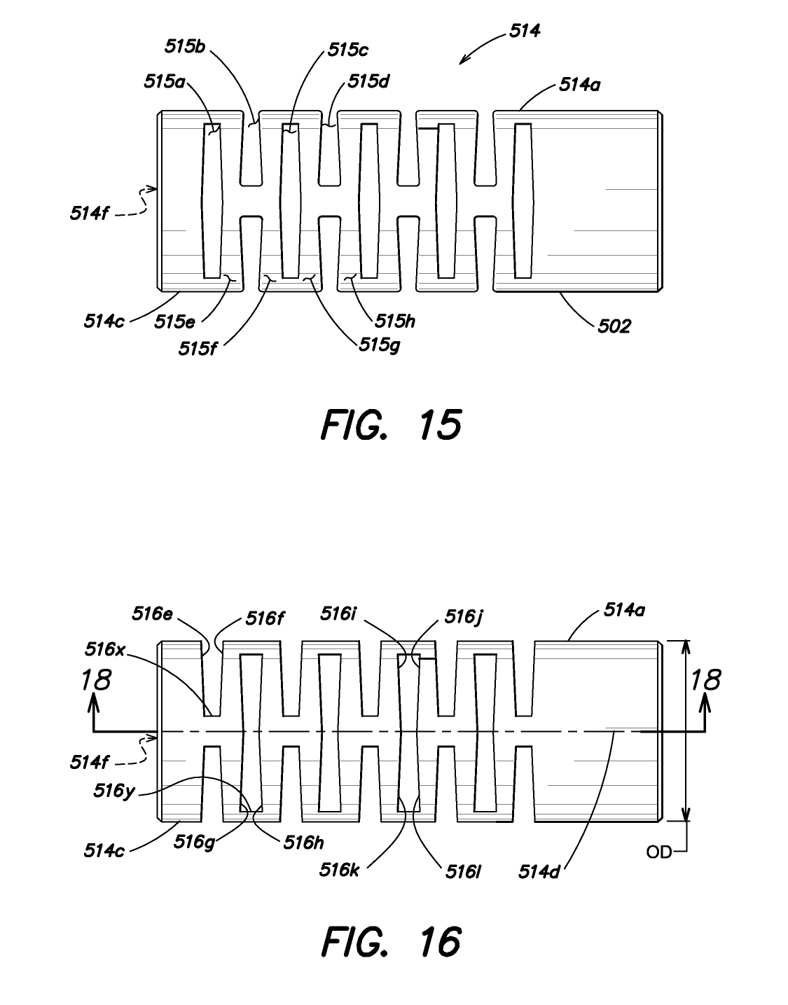

The interconnected alternating mesh pattern portion 514b has a central axis 514d (FIGS. 16, 18) and comprises a plurality of equally configured rectangular open spaces 515a, 515b, 515c, 515d (as shown in FIG. 15) between each mesh pattern in a relaxed state. Each mesh pattern 514b is comprised of a plurality of substantially rectangular inner walls 516a, 510, 516c, 516d (as shown on the inner circumferential surface (ID) 501 in FIG. 18), a plurality of substantially rectangular outer walls 515e, 515f, 515g, 515h (as shown on the outer circumferential surface (OD) 502 in FIG. 15), and a plurality of opposing sidewalls 516e, 516f, 516g, 516h (as shown in FIG. 16) which connect the inner and outer walls 501, 502 respectively. The opposing sidewalls 516e, 516f, 516g, 516h (connected by endwalls 516x, 516y) (as shown in FIG. 16) are radial cutouts across the tube wall and include planar linear portions 516i, 516j, 516k, 516l (as shown in FIG. 16) with respect to the central axis 514d. The tubular device 514 is thus a substantially cylindrical body 514e having a through bore 514f on the terminal portion 514c of the device 514; and where the planar linear portions 516i, 516j, 516k, 516l of the opposing sidewalls prevent the plurality of interconnected alternating mesh pattern portions 514b from slipping against each other when the device 514 is in a bent state (similar to that shown in FIG. 8B).

The plurality of interconnected alternating mesh pattern portions 514b are designed to abut against the exterior of the hose 2 and prevent the collapse or kinking of the hose portion located inside the device. The device 514 can be made from durable materials that will withstand temperature and weather changes. In an aspect, the device 514 is made from synthetic polymers, such as nylon and plastics, including thermosetting and thermoplastics, selected from the group consisting of acrylonitrile butadiene styrene (ABS), nylon, acrylics, celluloid, cellulose acetate, cyclic olefin copolymer, ethylene-vinyl acetate (EVA), ethylene vinyl alcohol (EVOH), fluoroplastics, polyacrylates, polyacrylonitriles, polyamides, polyamide-imide, polyaryletherketone, polybutadiene, polybutylene, polybutylene terephthalate, polycaprolactone, polychlorotrifluoroethylene, polycarbonate, polyester, polyethylene, polyetherimide, polyethersulfone, polyimide, polyphenylene oxide, polypropylene, polystyrene, polysulfone, polyurethane, polyvinyl acetate, polyvinyl chloride, polyvinylidene chloride, and styrene-acrylonitrile. Any plastic material with or without other nonplastic fillers may be used, so long as the mesh pattern portions are flexible and will bend along with the hose when a bending force, e.g., a strain, is applied to the hose.

FIG. 16 shows the alternating mesh pattern of the device rotated 90° about the central cylindrical axis 514d, with respect to FIG. 15. As shown in FIGS. 15-16, when the device 514 is rotated 90 degrees the alternating mesh pattern portion retains its congruous pattern. As shown in FIG. 16, the device 16 has a central axis 514d. As shown in FIG. 17 (end view), the terminal portion 514c of the device 514 can be smooth on both the outside and inside surfaces. The nonthreaded portion of the device can have substantially the same inner diameter ID throughout its length (see FIG. 18). The size of the inner diameter is not particular to the device, so long as a hose can be inserted there through and the threaded neck portion 514a of the device can attach onto a ferrule at an end of the hose.

As shown in FIG. 18, the neck portion 514a of the device has a threaded internal surface 505, here more specifically a helical threaded internal surface. In an alternative embodiment, the neck portion can have a grooved or corrugated internal surface, e.g., parallel concentric rings. However, the helical threaded internal surface 505 is preferred because it provides more surface contact area for attachment to the plurality of parallel concentric rings of a ferrule. Also, rotation of the helical threaded internal surface 505 of the device 514 and the rings of the ferrule will move the device 514 up (longitudinally along the cylindrical axis of) the ferrule, e.g., by using a twisting motion, to provide a tighter attachment to the ferrule.

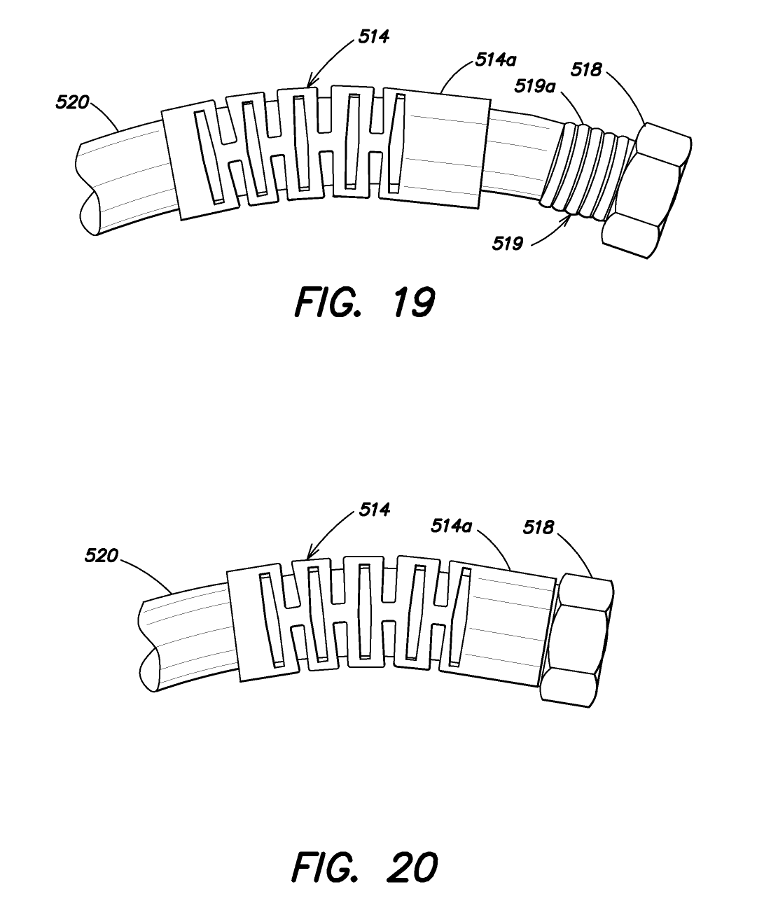

The device 514 can be attached to a ferrule at one end of a hose in a process similar to that illustrated in FIGS. 4-7. FIGS. 19-20, similar to FIGS. 6-7, show the device 514 positioned on an end portion of a typical garden or water hose 520, having at the end of the hose a ferrule 519 and coupler 518. The device 514 was previously inserted over the hose end portion, before attaching the ferrule 519 and coupler 518 (in a manner similar to that shown in FIGS. 4-6). Thus, after crimping the coupler 518 and ferrule 519 onto the hose 520, the neck portion 514a of the device 514 is then moved up and over the outer surface of the ferrule, as shown in FIG. 20. In particular, the threaded internal surface 505 of the device 514 can engage the parallel concentric rings 519a on the outer surface of the ferrule 519, as shown in FIGS. 19-20. In an aspect, the device can be twisted onto the ferrule thereby allowing the threaded internal surface to move up and over the parallel concentric rings. In this manner, the device can be attached to the ferrule when in use and can be unattached from the ferrule when it is no longer needed.

While specific embodiments of the present invention have been shown and described, it should be apparent that many modifications can be made thereto without departing from the spirit and scope of the invention. Accordingly, the invention is not limited by the foregoing description, but is only limited by the scope of the claims appended thereto.

What is claimed is:

1. A hose system comprising;
a hose inserted through a device comprising:
a substantially cylindrical body having a through bore on a terminal portion;
a neck portion having a groove or threaded internal surface; and
a plurality of interconnected alternating mesh pattern portions connecting the neck portion and the terminal portion;
wherein the plurality of interconnected alternating mesh pattern portions has a central axis comprising a plurality of equally configured rectangular open spaces between each mesh pattern in a relaxed state, each mesh pattern comprising a plurality of substantially rectangular inner walls, and a plurality of substantially rectangular outer walls, and a plurality of opposing sidewalls connecting the inner and outer walls; and wherein the opposing sidewalls include planar linear portions with respect to the central axis.

2. The hose system of claim 1, wherein the device has substantially the same diameter throughout the length of the device.

3. The hose system of claim 1, wherein the device is made of durable materials.

4. The hose system of claim 1, wherein the device is made from a synthetic polymer.

5. The hose system of claim 4, wherein the synthetic polymer is selected from the group consisting of acrylonitrile butadiene styrene (ABS), nylon, acrylics, celluloid, cellulose acetate, cyclic olefin copolymer, ethylene-vinyl acetate (EVA), ethylene vinyl alcohol (EVOH), fluoroplastics, polyacrylates, polyacrylonitriles, polyamides, polyamide-imide, polyaryletherketone, polybutadiene, polybutylene, polybutylene terephthalate, polycaprolactone, polychlorotrifluoroethylene, polycarbonate, polyester, polyethylene, polyetherimide, polyethersulfone, polyimide, polyphenylene oxide, polypropylene, polystyrene, polysulfone, polyurethane, polyvinyl acetate, polyvinyl chloride, polyvinylidene chloride, and styrene-acrylonitrile.

6. An anti kinking device for a hose system comprising:
a substantially cylindrical body made of a synthetic polymer material having a through bore on a terminal portion;
a neck portion having a grooved or threaded internal surface; and
a plurality of interconnected alternating mesh pattern portions connecting the neck portion and the terminal portion;
wherein the plurality of interconnected alternating mesh pattern portions has a central axis comprising a plurality of equally configured rectangular open spaces between each mesh pattern in a relaxed state, each mesh pattern comprising a plurality of substantially rectangular inner walls, and a plurality of substantially rectangular outer walls, and a plurality of opposing sidewalls connecting the inner and outer walls; and
wherein the opposing sidewalls include planar linear portions with respect to the central axis; and
wherein the planar linear portions of the opposing sidewalls prevent the plurality of interconnected alternating mesh pattern portions from slipping against each other when the device is in a bent state.

7. A hose system comprising a hose inserted through the anti-kinking device of claim 6.

8. The hose system of claim 7, wherein the device relieves a strain on the hose.

9. The hose system of claim 7, further comprising a ferrule attached to an end of the hose, the ferrule having a plurality of parallel concentric rings on an outer surface of the ferrule, wherein the neck portion of the device is twisted onto the concentric rings on the outer surface of the ferrule.

10. The hose system of claim 9, wherein the internal surface of the neck portion of the device is threaded for attaching to the ferrule.

11. The hose system of claim 7, wherein the hose is used for potable water.

12. The hose system of claim 7, wherein the hose is made from soft vinyl plastic, natural rubber, synthetic rubber or thermoplastic rubber.

13. The hose system of claim 11, wherein the hose system further comprises a female end of the hose.

14. The hose system of claim 13, wherein a ferrule is crimped onto the female end of the hose.

15. The hose system of claim 14, wherein the ferrule has a plurality of parallel concentric rings on the outer surface of the ferrule on the female end of the hose and the neck portion has a helical threaded internal surface that is twisted onto the concentric rings of the ferrule.
